(19) United States
(12) Patent Application Publication
(10) Pub. No.: US 2026/0353337 A1
(43) Pub. Date: Nov. 5, 2026

(54) Managing a Positioning Service in Mobile Communication Network

(71) Applicant: Telefonaktiebolaget LM Ericsson (publ), Stockholm (SE)

(72) Inventors: Zhan Zhang, Beijing (CN); Yufei Blankenship, Kildeer, IL (US)

(21) Appl. No.: 19/116,341

(22) PCT Filed: Sep. 27, 2023
(86) PCT No.: PCT/EP2023/076737

§ 371 Date: Mar. 27, 2025

(30) Foreign Application Priority Data
Oct. 3, 2022 (WO) PCT/CN2022/123691

(51) Int. Cl. H04W 64/00; H04W 24/04; H04W 24/08

(52) U.S. Cl. CPC H04W 64/00; H04W 24/04; H04W 24/08

(57) ABSTRACT

The present disclosure proposes a method for managing a positioning service provided to one or more UEs by a positioning model in a mobile communication network, the method comprising: constantly monitoring one or more Key Performance Indicators (KPIs) about the positioning service, and adjusting the positioning model in an attempt to maintain the positioning service at a service grade, if the one or more KPIs indicate that the positioning service cannot reach the service grade. Through the management of the present disclosure, the positioning service could constantly maintain a desired service grade and keep MI or HMI at very low probability, or explicitly announce unavailability of the service grade if e.g., a certain level of positioning accuracy is not possible with all of the available resources and/or adjustments.

### CROSS REFERENCE TO RELATED APPLICATION

This application claims priority of PCT application serial number PCT/CN2022/123691 filed on Oct. 3, 2022 with title of “METHODS AND APPARATUSES FOR MANAGING A POSITIONING SERVICE IN MOBILE COMMUNICATION NETWORK”, the entire contents of which are incorporated herein by reference.

### TECHNICAL FIELD

The non-limiting and example embodiments of the present disclosure generally relate to the technical field of mobile communication network, and specifically to methods and apparatuses for managing a positioning service in mobile communication network.

### BACKGROUND

This section introduces aspects that may facilitate a better understanding of the disclosure. Accordingly, the statements of this section are to be read in this light and are not to be understood as admissions about what is in the prior art or what is not in the prior art.

A User Equipment (UE) in a mobile communication network often needs to know its position to enjoy some position-based services, such as a navigation service on an electronic map in the UE. The position data may be supplied to the UE by a positioning service in the mobile communication network. Nowadays, the positioning service has became one of the most basic services provided by most mobile communication networks. In addition, if a Misleading Information (MI) or Hazardous Misleading Information (HMI) is kept at very low probability in a positioning service, this will offer a great added value to the positioning service besides the positioning values themselves.

The positioning service may be provided by a positioning model. For example, 3GPP specified a positioning model based on geometric calculation of time measurements, presuming that propagation environments are dominated by the Line of Sight (LOS) propagation condition between the radio base station antenna and the UE. FIG. 1, coming from “Positioning in 5G Networks” (in IEEE Communications Magazine, vol. 59, no. 11, pp. 38-44, November 2021, S. Dwivedi et al., doi: 10.1109/MCOM.011.2100091), illustrates an example positioning architecture and logical protocols among different entities applicable in a 5^{th} Generation (5G) network, wherein the protocols between the entities are shown using colored dashed lines.

However, the LOS propagation condition may not always dominate propagation environments. As illustrated in FIG. 2, when the signal propagation is reflected by walls, a multi-path channel will be generated. Different radio propagations could result in quite different channel features, such as channel coherent bandwidth, channel variation over time and space. When it comes to an indoor environment, the channel becomes very multipath and the LOS propagation condition is seldomly available, especially when the indoor environment is fully occupied with a lot of so-called clutters, such as machines and storages.

To provide accurate positioning service in e.g., indoor environment, people now start to consider using Artificial Intelligence (AI) and Machine Learning (ML) for positioning service. Learning capability of AI creates advantageous policies or strategies directly based on data, symbolic modeling and analysis instead of human logics. AI/ML enabled solutions essentially employ data-driven learning approaches where the models learn the underlying data distribution and relationship between the inputs and outputs without the need for understanding the underlying complex processes. AI/ML has been found to be an effective tool in radio positioning.

3GPP also has now been investigating on AI/ML based positioning method, i.e., channel state information or time of arrival measurements based so-called fingerprint positioning method, especially for indoor environment. For example, the following table from 3GPP Technical Report (TR) 38.901 V16.1.0 (Technical Specification Group Radio Access Network; “Study on channel model for frequencies from 0.5 to 100 GHz (Release 16)”) lists the modelling of the indoor factory scenario.

Recent discussion at 3GPP indicated some potential accuracy gain at some indoor cases by AI/ML positioning model, and some existing simulation even indicated a great advance in accuracy.

### SUMMARY

However, the inventors of the present disclosure find, there is a precondition for the AI/ML positioning model, that is the measurement data of radio signal features (time delay or Reference Signal Receiving Power, channel impulse responses, etc.) should have high quality and be coherent to the data at deployment. In reality, those features might be time-varying due to many factors, such as indoor radio environment being changed by change of locations of indoor devices. In addition, other aspects of radio environment change such as occasional time-asynchronization or interference could result in the AI/ML positioning model becoming invalid or degraded seriously.

Other positioning models have a similar problem. For example, the current positioning model based on geometric calculation of time measurements in 3GPP, which is also called as a legacy positioning model in the present disclosure, is established presuming that propagation environments are dominated by the LOS propagation condition, while the LOS propagation condition may not always dominate propagation environments, which may also make the legacy positioning model invalid or degraded.

In sum, although a position model might function quite well with a satisfactory service grade for some use cases or periods, it might become degraded or even totally malfunction in other occasions.

To resolve or alleviate the above problem, which is one of the objects of the present disclosure, the inventors of the present disclosure conceive of setting up a mechanism in the positioning system of a mobile communication network (for example, Radio Access Network (RAN) or Radio network may act as a positioning service provider in the mobile communication network) to continuously manage the life cycle of the positioning service provided by a positioning module (e.g., together with its inference network) in the mobile communication network, in an attempt to maintain the positioning service at a desirable service grade.

According to a first aspect of the present disclosure, the object is achieved by a method for managing a positioning service provided to one or more UEs by a positioning model in a mobile communication network, wherein the positioning model comprises one or both of a legacy positioning model and an AI/ML positioning model, the method comprising: constantly monitoring one or more Key Performance Indicators (KPIs) for the positioning service, and adjusting the positioning model to maintain the positioning service at a service grade, if the one or more KPIs indicate that the positioning service cannot reach the service grade.

According to a second aspect of the present disclosure, the object is achieved by a managing module for managing a positioning service provided to one or more UEs by a positioning model in a mobile communication network, wherein the positioning model comprises one or both of a legacy positioning model and an AI/ML positioning model, the managing module comprising: a monitoring unit, for constantly monitoring one or more Key Performance Indicators (KPIs) for the positioning service, and an adjusting module, for adjusting the positioning model to maintain the positioning service at a service grade, if the one or more KPIs indicate that the positioning service cannot reach the service grade.

According to a third aspect of the present disclosure, the object is achieved by a managing module for managing a positioning service provided to one or more UEs by a positioning model in a mobile communication network, the managing module being configured to perform the method according to the first aspect.

According to a fourth aspect of the present disclosure, the object is achieved by a managing module for managing a positioning service provided to one or more UEs by a positioning model in a mobile communication network, the managing module comprising: a processor; and a memory, having stored instructions that when executed by the processor cause the managing module to perform the method of according to the first aspect.

According to a fifth aspect of the present disclosure, the object is achieved by a machine readable medium having stored thereon instructions that when executed on a managing module cause the managing module to perform the method according to the first aspect.

According to a sixth aspect of the present disclosure, the object is achieved by a positioning system, comprising: a positioning module, for providing a positioning service to one or more UEs in a mobile communication network through a positioning model in the positioning module; and the above managing module.

Through the management of the present disclosure (it may also be called as Life Cycle Management, LCM), the positioning service could constantly maintain a desired service grade and keep MI or HMI at very low probability, or explicitly announce unavailability of the service grade if e.g., a certain level of positioning accuracy is not possible with all of the available resources and/or adjustments.

### BRIEF DESCRIPTION OF THE DRAWINGS

The above and other aspects, features, and benefits of the present disclosure will become more fully apparent from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an example positioning architecture and logical protocols among different entities applicable in a 5G network;

FIG. 2 illustrates an example scenario of radio propagation;

FIG. 3 illustrates a flowchart of the method for managing a positioning service provided to one or more UEs by a positioning model in a mobile communication network according to the present disclosure;

FIG. 4 is a schematic block diagram of a managing module according to the present disclosure.

FIG. 5 is another schematic block diagram of a managing module according to the present disclosure.

FIG. 6 is a schematic block diagram of a positioning system according to the present disclosure.

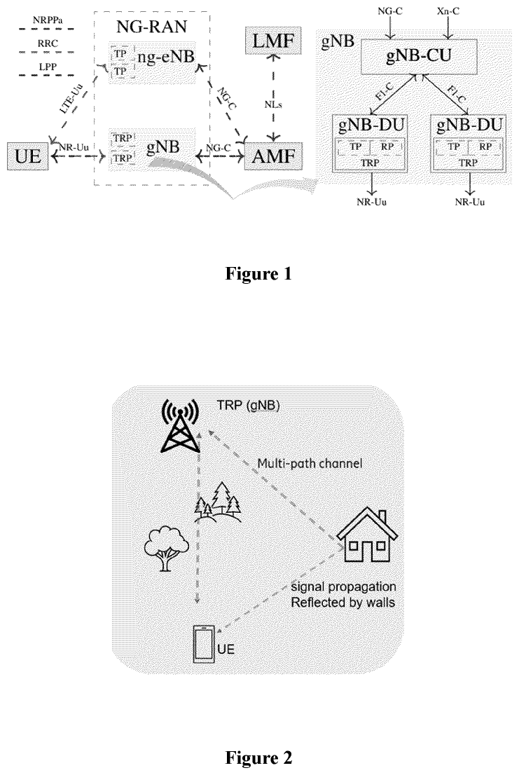

### DETAILED DESCRIPTION

Embodiments herein will be described more fully hereinafter with reference to the accompanying drawings. The embodiments herein may, however, be embodied in many different forms and should not be construed as limiting the scope of the appended claims.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., herein to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

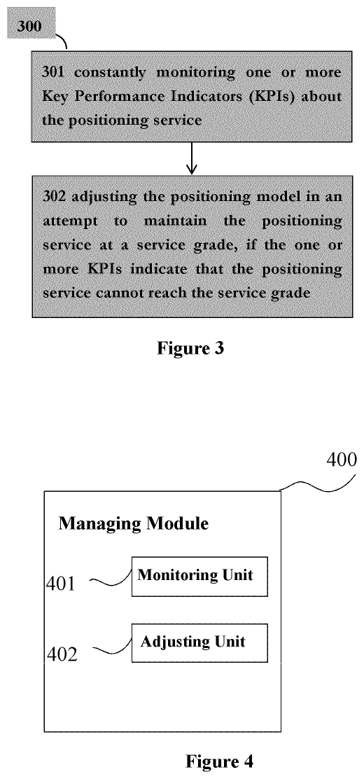

A flowchart of a method 300 for managing a positioning service provided to one or more UEs by a positioning model in a mobile communication network in shown in FIG. 3, wherein the positioning model comprises one or both of a legacy positioning model and an AI/ML positioning model. The method 300 comprising: a step 301 of constantly monitoring one or more Key Performance Indicators (KPIs) for the positioning service, and a step 302 of adjusting the positioning model to maintain the positioning service at a service grade, if the one or more KPIs indicate that the positioning service cannot reach the service grade.

In an embodiment, the adjusting is made by taking into consideration performance of both the legacy positioning model and the AI/ML positioning model.

In an embodiment, the positioning model is deployed in the network, or the UE, or both.

In an embodiment, the one or more KPIs include one or more of: a positioning accuracy and integrity, a latency metric, an availability, and power consumption and/or energy consumption

In an embodiment, the positioning model is the legacy positioning model before the adjusting, and the adjusting comprises: replacing the legacy positioning model with the AI/ML positioning model as the positioning model, or making the legacy positioning model and the AI/ML positioning model to cooperate as the positioning model.

In an embodiment, the positioning model is the AI/ML positioning model before the adjusting, and the adjusting comprises one or more of: providing the AI/ML positioning model with updated measurement data, updating parameters of the AI/ML positioning model, and replacing the AI/ML positioning model with the legacy positioning model as the positioning model.

In an embodiment, the method further comprises: choosing the AI/ML positioning model according to the service grade.

In a further embodiment, the method further comprises: configuring a data path, the one or more UEs and/or one or more input source network nodes in the mobile communication network for data measurement required by the chosen AI/ML positioning model.

In an embodiment, the method further comprises: triggering the one or more UEs to send measurement data to the AI/ML positioning model for training the AI/ML positioning model, before using the AI/ML positioning model.

In a further embodiment, the method further comprises: communicating with the one or more UEs about the measurement capability of the one or more UEs, before the triggering.

In an embodiment, the method further comprises: making a trial operation of the AI/ML positioning model before using the AI/ML positioning model.

In an embodiment, the AI/ML positioning model is specific to a UE capability, a base station or a cell in the mobile communication network.

In an embodiment, the method further comprises: causing broadcast of the service grade to the one or more UEs.

In an embodiment, the method further comprises: instructing the one or more UEs and one or more network nodes involved in the positioning service in the mobile communication network to allocate resources for the positioning service.

In an embodiment, the method of any one of claims further comprises: announcing unavailability of the positioning service if the positioning service cannot reach the service grade after the adjusting.

In an embodiment, the method further comprises: configuring the one or more UEs and one or more network nodes involved in the positioning service in the mobile communication network to provide feedback for monitoring the one or more KPIs.

In an embodiment, the method further comprises: triggering Misleading Information (MI) or Hazardous Misleading Information (HMI) sharing or integrity status information sharing, if the one or more KPIs indicate that the positioning service is beyond a predefined alert level.

In an embodiment, the legacy positioning model is based on geometric calculation.

In an embodiment, the method is performed by a LCM module in the mobile communication network.

The present disclosure also provides a managing module for managing a positioning service provided to one or more UEs by a positioning model in a mobile communication network, and the managing module is configured to perform the above method. The managing module according to the present disclosure may also be called as an LCM module in the following, which may be deployed in the network, or the UE, or both.

Now, specific examples of the above embodiments will be described in connection with a 5G network. It can be understood that, although the examples/embodiments herein are described in the context of the 5G network, the examples/embodiments can be also applied to other mobile communication networks, if the same problem exists in their mechanisms for positioning of a UE. It will be also understood that, although specific terms are used in the examples/embodiments, the examples/embodiments are not limited to those specific terms but may be applied to all similar entities. For example, the “User Equipment”/“UE” herein may refer to e.g., user terminal, station, terminal, terminal node, and so on.

### I. The KPIs (or Metrics) to be Monitored at Life-Cycle-Management of a Positioning Service

In an attempt to ensure that the positioning service provided by the positioning model meets the desired service grade, one or more KPIs are monitored. Some exemplary KPIs are described in detail below.

### (1) Positioning Accuracy and Integrity

The positioning accuracy (e.g., horizontal and vertical accuracy) and integrity may be reflected by such as:
errors in assistance data, e.g., Transmission Reception Point (TRP) location, Inter-TRP synchronization errors (e.g., Round Trip Delay, RTD);
errors in measurements, e.g., Time of Arrival (ToA), Rx-Tx timing difference;
errors due to the radio environment (e.g., multi-path);
errors from AI/ML model drift.

### (2) Latency (Note: At Initialization of the Positioning System, the Latency is Also Defined as the Time to First Fix (TTFF).)

The latency metric may refer to (i) end-to-end latency for position estimation of the UE; and/or (ii) physical layer latency for position estimation of the UE.

If the positioning model is not able to provide position estimate of the target UE within the target latency (e.g., 1 sec latency requirement), then the managing module may generate an indicator that the model needs to be updated, optionally with a reason being e.g., “target latency requirement is not satisfied”.

### (3) Availability

The availability is e.g., percentage of time (probability of occasions) when a positioning system is able to provide the required position data within the performance targets or requirements.

For example, a use case (e.g., tracking of medical equipment in hospital) may have the requirement of 99% availability. Thus, the monitoring module may need to record statistics on availability. If the positioning model fails to provide position data to meet the availability requirement (e.g., as required by the desired service grade), then the monitoring module may generate an indicator that the model needs to be updated, optionally with a reason being e.g., “target availability requirement is not satisfied”. For instance, an AI/ML model trained for an environment with <=40% clutter may not be able to provide positioning service if deployed in an environment with 50% clutter, resulting in poor availability.

(4) Power Consumption and/or Energy Consumption

Power consumption may be e.g., electrical power (usually in mW) used by e.g., the positioning system to produce the position data.

Energy consumption may be e.g., energy per fix, which is energy (usually in mJ per fix) used by e.g., the positioning system to produce the position data. It represents the integrated energy consumption of the positioning system over the required processing interval.

Power consumption/energy consumption is an important metric for Internet of Things (IoT) devices or wearables (e.g., smart watch, AR/VR goggles). The positioning model may need to be divided into two different versions for deployment: a normal power version for UEs that do not have stringent low power requirement; a low power version for UEs that prefer to sacrifice other performance metrics (e.g., positioning accuracy) in order to save power consumption. For an AI/ML positioning model, the low power version may use a smaller neural network structure and fewer quantization bits.

Thus, the managing module may need to keep track of power/energy consumption of the UE. When the power/energy consumption is detected to be above a certain level, then the managing module may generate an indicator that the positioning model needs to be updated, optionally with a reason being e.g., “power consumption above the threshold”, or “energy consumption above the threshold”.

### II. Operations of the Managing Module

The operations of the manage module according to the present disclosure, or the LCM module, may be corresponding to the steps of the method according to the present disclosure. Some exemplary operations of the LCM module are described in detail below.

(1) Defining, or Choosing an AI/ML Positioning Model and Announcing Positioning Service Levels (Including e.g., KPIs, Alert Limit Level, and/or Protection Level) for Different Service Grades
(a) Maintaining and updating system information on service grade: Different measurement data and positioning AI/ML positioning models are selected according to service grades; the LCM module could provide diversified models per service grade and configure the operation of AI/ML positioning model with different inference deployment and/or data-path for measurement data to the positioning model.
(b) Service grade identity for communicating/sharing: the LCM module optionally causes broadcast of the grades of services for positioning to the UEs (such as by configuring the base stations to broadcast system info including the service grades to the UEs at RAN operations) and employs protocol to communicate with the UEs about their proper configurations to provide measurement data.

### (2) Identifying Insufficiency of the Current Positioning Model

The LCM module may monitor constantly one or more KPIs about the positioning service and determine whether the positioning model (such as a legacy positioning model based on geometric calculating-based radio positioning) becomes insufficient to satisfy a target service grade. For example, where there are inadequate LOS coverage (e.g., due to change of radio environment), a legacy positioning model becomes unable to provide a positioning service at a certain service grade.

### (3) Determining the Inputs and Parameters of the AI/ML Positioning Model

(a) Based on the chosen AI/ML positioning model, the LCM function may configure the input source network nodes and/or functions, such as by communicating with the base stations, e.g., via a path or aid from an Access and Mobility Management Function (AMF), about such as:
   inputs source ID, data types, periodicity (timing) of the data reporting.
(b) The LCM function may configure AI/ML models specific to UE/base station/cell.
   i. The AI/ML positioning model ID: There may be separate AI/ML positioning models to support different UE capability in its measurements or reporting or TRP/base station capability.
   ii. The AI/ML positioning model IDs per sector: Different cell/sector might need its specific AI/ML positioning model, and the AI/ML positioning model may host ID(s) of node(s).

### (4) Activating the Data Collection Phase for Learning/Training of the AI/ML Positioning Model

(a) The LCM module may trigger the measurement source devices to operate, e.g., instruct/configure the UE via its positioning user ID and configuration, to send out measurement reports, and set up paths (node ID list) for the reports to reach the positioning anchor function, or choose one AI/ML positioning model from database of pre-trained models,
(b) The LCM module may communicate with the UE about its computing/measurement capability according to capability category, to determine the available measurement richness/latency/suitability for the AI/ML positioning model, and eventually the available service level.

### (5) Initiating the Trial Operation of the AI/ML Positioning Model and Checking/Benchmarking its Performance at Trial Phase

(a) By comparing to the existing positioning service and targeted service grade, the LCM module may determine initiation of an AI/ML positioning model.
(b) At the trial phase, the AI/ML positioning model may shadow the legacy positioning model. That is, the AI/ML positioning model is running at the same time as the legacy positioning model, where the service of UE position determination is produced by the legacy positioning model. The output of the AI/ML positioning model is used for AI/ML model performance monitoring and calibration, not for service to the end user.
(c) When a decision is made to use the AI/ML positioning model for the positioning service, the LCM module may switch off the legacy positioning model or suspend it and replace it by the AI/ML positioning model for generating position data.
   (6) Configuring Periodically or Occasionally Feedback about e.g., Accuracy of the AI/ML Positioning Model at a Network-Side Positioning Control Anchor, Such as Next Generation RAN Location Management Function (LMF), to the LCM Module.

The LCM module may configure the feedbacks from both network TRPs and/or UEs, or through LMF, and the feedbacks are used by the LCM module to monitor one or more KPIs, in turn to determine whether the service grade (e.g., service integrity) is met for the positioning service or not.

### (7) Triggering Misleading Information (MI) or Hazardous Misleading Information (HMI) Sharing or Integrity Status Info Sharing,

The LCM module may trigger MI or HMI sharing or integrity status info sharing, if the one or more KPIs indicate that the positioning service is beyond a predefined alert level.

### (8) Activating Tuning Phase of the AI/ML Positioning Model and Collecting More Data for the Tuning Phase

The LCM module may configure nodes to start the AI/ML positioning model tuning with refreshed measurement data or directly update the parameters for the AI/ML positioning model from a source (configure a source ID of a database).

### (9) Triggering Fallback to the Legacy Positioning Model

(a) If the AI/ML positioning model is not able to meet the service grade but fallback to the legacy positioning model could meet the service grade, then the LCM module would establish a fallback to the legacy positioning model.
(b) If all options (e.g., replacing the current positioning model with a legacy or AI/ML positioning model, or updating the parameters of the AI/ML positioning model) for adjusting the positioning model are incapable of satisfy the service grade for the positioning service, the LCM may announce the unavailability of the positioning service.

### (10) Checking Opportunity to Restart the AI/ML Positioning Model

Whenever the positioning service being provided by the legacy positioning model cannot reach the service grade, the LCM module may check if an AI/ML positioning model or making the legacy positioning model and AI/ML positioning model cooperate could help the positioning service to achieve the service grade, e.g., by making trial operation of the AI/ML positioning model and checking its performance. If so, the LCM module may replace the legacy positioning model with the AI/ML positioning model as the positioning model, or make the legacy positioning model and the AI/ML positioning model to cooperate as the positioning model.

### (11) Instructing the UE(s) and Network Node(s) Involved in the Positioning Service to Allocate Resources for the Positioning Service

The LCM module may instruct/inform e.g., the UEs and base stations of the operational requirements such as computing resource/data-path capacity demands for them to allocate resources for e.g., signaling, and network side's computing resources for supporting the positioning service.

FIG. 4 illustrates a schematic block diagram of a managing module 400 according to the present disclosure. The managing module 400 is used for managing a positioning service provided to one or more UEs by a positioning model in a mobile communication network. The managing module 400 may include: a monitoring unit 401, for constantly monitoring one or more KPIs for the positioning service, and an adjusting unit 402, for adjusting the positioning model to maintain the positioning service at a service grade, if the one or more KPIs indicate that the positioning service cannot reach the service grade.

It can be appreciated that, the managing module 400 described herein may be implemented by various units, so that the managing module 400 implementing one or more functions described with the embodiments may comprise not only the units shown in the corresponding figure, but also other units for implementing one or more functions thereof. In addition, the managing module 400 may comprise a single unit configured to perform two or more functions, or separate units for each separate function. Moreover, the units may be implemented in hardware, firmware, software, or any combination thereof.

It is understood that blocks of the block diagrams and/or flowchart illustrations, and combinations of blocks in the block diagrams and/or flowchart illustrations, may be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

It is also to be understood that the functions/acts noted in the blocks of the flowchart may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Furthermore, the solution of the present disclosure may take the form of a computer program on a memory having computer-usable or computer-readable program code embodied in the medium for use by or in connection with an instruction execution system. In the context of this document, a memory may be any medium that may contain, store, or is adapted to communicate the program for use by or in connection with the instruction execution system, apparatus, or device.

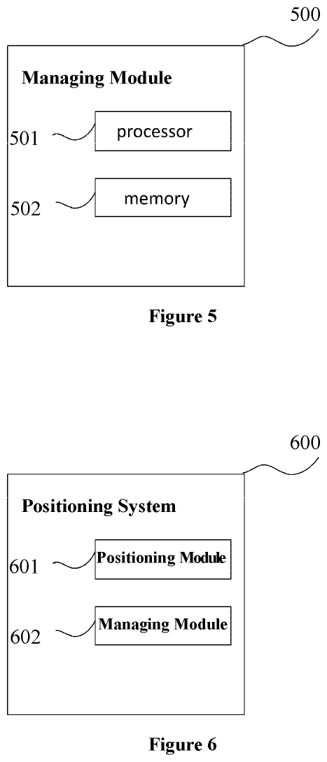

Therefore, the present disclosure also provides a managing module 500 including a processor 501 and a memory 502, as shown in FIG. 5. In the managing module 500, the memory 502 stores instructions that when executed by the processor 501 cause the managing module 500 to perform the method of the managing module described above with the embodiments.

The present disclosure also provides a machine readable medium (not illustrated) having stored thereon instructions that when executed on a managing module cause the managing module to perform the method of the managing module described with the above embodiments.

The present disclosure also provides a positioning system 600 as shown in FIG. 6, comprising: a positioning module 601, for providing a positioning service to one or more UEs in a mobile communication network through a positioning model in the positioning module; and the managing module 602 as described above. Moreover, the positioning system according to the present disclosure may include the positioning model and the managing module without the positioning module.

Each of the positioning model, the positioning module and the managing module in the present disclosure can be implemented as a network element on a dedicated hardware, as a software instance or a firmware running on a hardware, as a virtualized function instantiated on an appropriate platform (e.g., on a cloud infrastructure), or as any combination thereof. In addition, the positioning system in the present disclosure may be implemented on multiple network nodes/network functions in a distributed manner, or on a single network node/network function.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-23. (canceled)

24. A method for managing a positioning service provided to one or more User Equipments (UEs) by a positioning model in a mobile communication network, wherein the positioning model comprises one or both of a legacy positioning model and an Artificial Intelligence/Machine Learning (AI/ML) positioning model, the method comprising:
constantly monitoring one or more Key Performance Indicators (KPIs) for the positioning service, and
adjusting the positioning model to maintain the positioning service at a service grade, responsive to the one or more KPIs indicating that the positioning service cannot reach the service grade.

25. The method of claim 24, wherein the adjusting is made by taking into consideration performance of both the legacy positioning model and the AI/ML positioning model.

26. The method of claim 24, wherein the positioning model is deployed in the network, or the UE, or both.

27. The method of claim 24, wherein the one or more KPIs comprise one or more of:
a positioning accuracy and integrity,
a latency metric,
an availability, and
power consumption and/or energy consumption.

28. The method of claim 24, wherein the positioning model is the legacy positioning model before the adjusting, and the adjusting comprises:
replacing the legacy positioning model with the AI/ML positioning model as the positioning model, or
making the legacy positioning model and the AI/ML positioning model to cooperate as the positioning model.

29. The method of claim 24, wherein the positioning model is the AI/ML positioning model before the adjusting, and the adjusting comprises one or more of:
providing the AI/ML positioning model with updated measurement data,
updating parameters of the AI/ML positioning model, or
replacing the AI/ML positioning model with the legacy positioning model as the positioning model.

30. The method of claim 24, further comprising:
choosing the AI/ML positioning model according to the service grade from a database of pre-trained AI/ML models.

31. The method of claim 30, further comprising:
configuring a data path, the one or more UEs and/or one or more input source network nodes in the mobile communication network for data measurement required by the chosen AI/ML positioning model.

32. The method of claim 24, further comprising:
triggering the one or more UEs to send measurement data to the AI/ML positioning model for training the AI/ML positioning model, before using the AI/ML positioning model.

33. The method of claim 32, further comprising:
communicating with the one or more UEs about the measurement capability of the one or more UEs, before the triggering.

34. The method of claim 24, further comprising:
making a trial operation of the AI/ML positioning model before using the AI/ML positioning model.

35. The method of claim 24, further comprising causing broadcast of the service grade to the one or more UEs.

36. The method of claim 24, further comprising instructing the one or more UEs and one or more network nodes involved in the positioning service in the mobile communication network to allocate resources for the positioning service.

37. The method of claim 24, further comprising:
announcing unavailability of the positioning service responsive to the positioning service not reaching the service grade after the adjusting.

38. The method of claim 24, further comprising:
configuring the one or more UEs and one or more network nodes involved in the positioning service in the mobile communication network to provide feedback for monitoring the one or more KPIs.

39. The method of claim 24, further comprising:
triggering Misleading Information (MI) or Hazardous Misleading Information (HMI) sharing or integrity status information sharing, responsive to the one or more KPIs indicating that the positioning service is beyond a predefined alert level.

40. The method of claim 24, wherein the legacy positioning model is based on geometric calculation.

41. The method of claim 24, wherein the method is performed by a Life Cycle Management (LCM) module in the mobile communication network.

42. A Life Cycle Management (LCM) module for managing a positioning service provided to one or more User Equipments (UEs) by a positioning model in a mobile communication network, the LCM module comprising:
a processor; and
a memory, having stored instructions that when executed by the processor cause the LCM module to:
constantly monitor one or more Key Performance Indicators (KPIs) for the positioning service; and
adjust the positioning model to maintain the positioning service at a service grade, if the one or more KPIs indicate that the positioning service cannot reach the service grade.

43. A positioning system, comprising:
a positioning module, for providing a positioning service to one or more User Equipments (UEs) in a mobile communication network through a positioning model in the positioning module; and
a Life Cycle Management (LCM) module comprising:
a processor; and
a memory, having stored instructions that when executed by the processor cause the LCM module to:
constantly monitor one or more Key Performance Indicators (KPIs) for the positioning service; and
adjust the positioning model to maintain the positioning service at a service grade, if the one or more KPIs indicate that the positioning service cannot reach the service grade.
